(19) United States
(12) Patent Application Publication
(10) Pub. No.: US 2015/0292392 A1
(43) Pub. Date: Oct. 15, 2015

(54) THROTTLE CONTROL SYSTEM AND METHOD

(71) Applicant: Arnold Magnetic Technologies, Rochester, NY (US)

(72) Inventor: Larry A. Kubes, Indianapolis, IN (US)

(73) Assignee: Arnold Magnetic Technologies, Rochester, NY (US)

(21) Appl. No.: 14/253,403

(22) Filed: Apr. 15, 2014

(51) Int. Cl. F02B 33/40; F02D 41/00

(52) U.S. Cl. CPC F02B 33/40; F02D 41/0007

(57) ABSTRACT

A throttle control system for an Otto cycle combustion engine includes a compressor and an electric motor. The compressor is rotatable in both clockwise and counterclockwise directions, and has air inlet and outlet ports, the air outlet port being configured to provide intake air to an air intake system of the engine. The motor, operably connected to the compressor, is configured to operate in a first direction to rotate the compressor clockwise or counterclockwise, and in a second direction to rotate the compressor in a direction reverse of the first direction. An unobstructed air flow passage is disposed between the compressor and the air intake system of the engine. Operation of the motor in the first direction facilitates an increase in air pressure at the air intake system, and operation of the motor in the second direction facilitates a decrease in air pressure at the air intake system.

### BACKGROUND OF THE INVENTION

The present disclosure relates generally to a throttle control system, and particularly to a throttle control system for an Otto cycle combustion engine.

With the increasing need to improve automotive tailpipe exhaust emissions, it is becoming increasingly important to be able to further manipulate the combustion cycle. Turbochargers do an exemplary job of increasing the intake air charge pressure, which forces more air into the combustion chamber to increase power output. A benefit of this increase in power output is that a relatively smaller engine can now be used to achieve the same vehicle drivability and performance. Additional benefits result from this engine downsizing in that during idle conditions, such as at stoplights, a smaller engine burns less fuel than a larger engine, but still provides enough power to the vehicle to power accessories such as air conditioning compressors and power steering pumps at idle.

Engine downsizing with turbocharging is becoming very commonplace in the automotive industry. Current state of the art turbochargers use a turbine mounted in the exhaust stream to capture exhaust flow inertial and heat energy to turn a shaft that is coupled to a compressor to drive more air into the engine combustion chamber.

Four-stroke gasoline (also known as benzene or petrol, depending on the area of the world) engines, which are commonplace in the automotive industry, are typically of the Otto cycle type, which uses a throttle valve in the intake tract to control air flow into the engine. This throttle valve is controlled by a driver accelerator pedal input via mechanical cable or linkage, or electronic motor control, to regulate air flow into the engine. As the driver wishes higher engine speed or increased power to perform driving maneuvers, such as acceleration or climbing a hill, the throttle valve is opened more to allow increased air flow to the engine. In effect, the throttle valve controls the air flow into the engine from a low or no air flow condition to a maximum air flow condition. Engine intake air flow is directly proportional to engine power.

New trends in automotive turbocharging involve using an electric motor mounted to the turbocharger unit or to the individual components of the turbine and the compressor. These components are known as eTurbos, eTurbine, and eCompressor, respectively. Advanced power electronics have enabled inverters to be manufactured that can drive an electric motor to a highly controllable state, including clockwise and counterclockwise directions, and with very precise speeds and very rapidly changeable speeds from 0 to over 100,000 revolutions per minute (rpm).

While existing eTurbos, eTurbines and eCompressors may be suitable for their intended purpose, the art relating to automotive turbocharging systems would be advanced with a turbocharging system that offers additional opportunities to control and reduce exhaust emissions in an Otto cycle combustion engine.

This background information is provided to reveal information believed by the applicant to be of possible relevance to the invention. No admission is necessarily intended, nor should be construed, that any of the preceding information constitutes prior art against the invention.

### BRIEF DESCRIPTION OF THE INVENTION

An embodiment of the invention includes a throttle control system for an Otto cycle combustion engine having a compressor and an electric motor. The compressor is rotatable in both clockwise and counterclockwise directions, and has an air inlet port and an air outlet port, the air outlet port being configured to provide intake air to an air intake system of the Otto cycle combustion engine. The electric motor is operably connected to the compressor, and is configured to operate in a first direction to rotate the compressor in one of the clockwise direction and the counterclockwise direction, and in a second direction to rotate the compressor in the other of the clockwise direction and the counterclockwise direction, the second direction being reverse of the first direction. An unobstructed air flow passage is disposed between the compressor and the air intake system of the engine. Operation of the electric motor in the first direction facilitates an increase in air pressure at the air intake system, and operation of the electric motor in the second direction facilitates a decrease in air pressure at the air intake system.

Another embodiment of the invention includes a method of controlling a throttle of an Otto cycle combustion engine. In the method, an electric motor is operated in one of a first direction and a second direction, the second direction being reverse of the first direction. Via the electric motor, a compressor is rotated in one of a clockwise direction and a counterclockwise direction. Via the compressor, an air pressure is adjusted at an air intake system of the Otto cycle combustion engine, wherein the adjusting an air pressure includes one of increasing the air pressure and decreasing the air pressure.

The above features and advantages and other features and advantages of the invention are readily apparent from the following detailed description of the invention when taken in connection with the accompanying drawings. The above features and advantages and other features and advantages of the invention may also be combined with features and advantages of co-owned application Ser. No. ______ filed concurrently ______ entitled TURBOCHARGING SYSTEM AND METHOD and having attorney docket number ADT0004US, which is herein incorporated by reference in its entirety.

### BRIEF DESCRIPTION OF THE DRAWINGS

Referring to the exemplary non-limiting drawings wherein like elements are numbered alike in the accompanying Figures:

FIG. 1 depicts in block diagram form an automotive system that includes an Otto cycle combustion engine and a throttle control system for controlling the throttle of the Otto cycle combustion engine, in accordance with an embodiment of the invention; and

FIG. 2 depicts a flowchart of a method for controlling the throttle of the Otto cycle combustion engine, in accordance with an embodiment of the invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

An embodiment of the invention, as shown and described by the various figures and accompanying text, provides a throttle control system for an Otto cycle combustion engine absent a throttle valve (such as a butterfly valve for example, or a similar valve such as a cylinder valve for example) that is conventionally used to control the air flow into the air intake system of the engine.

Conventional throttle valves are typically butterfly valves, in most cases, but not all. This particular style of valve construction results in a disturbance of the air flow in the intake air stream due to the air flow regulating mechanism being placed directly in the air stream. This disturbance in the air flow causes a reduction in air flow as well as causing turbulent air flow, which is more difficult to monitor and determine the proper fuel flow required to make the engine run properly. By removing the throttling valve from the intake air flow, reductions in flow and turbulence can be minimized, resulting in performance and emissions improvements.

While the embodiment described and illustrated herein depicts an inline four cylinder configuration as an exemplary Otto cycle combustion engine, it will be appreciated that the disclosed invention is not so limited and is also applicable to other cylinder configurations, such as inline two cylinder, v-type two cylinder, inline three cylinder, inline five cylinder, inline six cylinder, v-type six cylinder, inline eight cylinder, v-type eight cylinder, inline ten cylinder, v-type ten cylinder, inline twelve cylinder, v-type twelve cylinder, and rotary engines having any number of combustion chambers, for example.

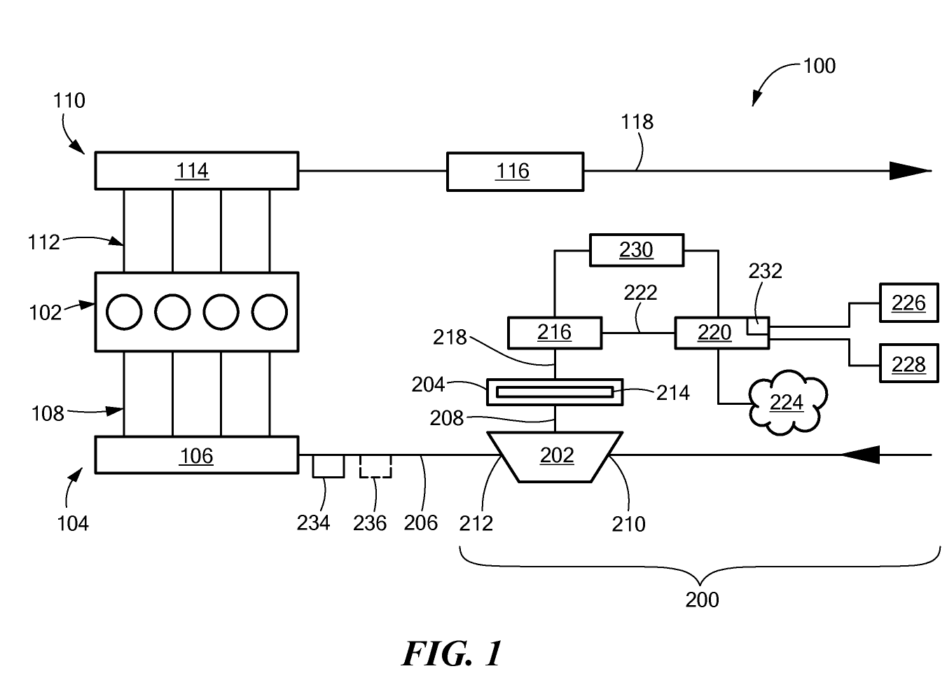

FIG. 1 depicts in block diagram form an automotive system 100 that includes an Otto cycle combustion engine (OCCE) 102 and a throttle control system (TCS) 200 for controlling the throttle of the OCCE 102. In flow communication with the OCCE 102 is an air intake system 104 that includes an intake manifold 106 and intake ports 108, and an exhaust output system 110 that includes exhaust ports 112 and an exhaust manifold 114. Exhaust gases from the exhaust manifold 114 pass through an exhaust system (catalytic converter and muffler for example) 116 and a tailpipe 118 to ambient.

The TCS 200 includes a compressor 202 configured to be rotatable in both clockwise and counterclockwise directions, an electric motor 204 operably connected to the compressor 202, and an unobstructed air flow passage 206 between the compressor 202 and the air intake system 104 of the OCCE 102. As used herein, it will be understood that reference to rotation of the compressor 202 means rotation of an internal blade, impeller or wheel of the compressor 202, which is disposed internal to a housing of the compressor 202. As used herein, the phrase operably connected means a mechanical connection to physically operate the compressor, an electrical wire connection to provide an electrical signal communication to operate the compressor, or a wireless signal communication to wirelessly operate the compressor. As used herein, the phrase unobstructed air flow passage means an air flow passage absent obstruction from a throttle valve. In an embodiment, the electric motor 204 has a permanent magnet rotor 214, and is directly connected to the compressor 202 via a rotatable shaft 208. However, it will also be appreciated that the electric motor 204 may be an asynchronous or a synchronous motor, such as an AC induction motor or a switched reluctance motor, respectively, as opposed to a (synchronous) permanent magnet motor.

The compressor 202 has an air inlet port 210 and an air outlet port 212, the air outlet port 212 being configured to provide intake air to the air intake system 104 of the OCCE 102 via the unobstructed air flow passage 206.

The electric motor 204 is configured to operate in a first direction to rotate the compressor 202 in one of the clockwise direction and the counterclockwise direction, and in a second direction to rotate the compressor 202 in the other of the clockwise direction and the counterclockwise direction, the second direction being reverse of the first direction, such that operation of the electric motor 204 in the first direction facilitates an increase in air pressure at the air intake system 104, and operation of the electric motor 204 in the second direction facilitates a decrease in air pressure at the air intake system 104.

In an embodiment, the electric motor 204 is controlled by a power inverter 216 that is operably connected to the electric motor 204 via signal line 218. The power inverter 216 is configured to transform input DC power to output AC power, where at least one of an output voltage and an output frequency of the AC power being provided to the electric motor 204 is adjustable, thereby enabling the speed and direction of rotation of the electric motor 204, and therefore the compressor 202, to be accurately controlled. Alternatively, the electric motor 204 may be controlled by an AC power supply, or the electric motor 204 may be a DC motor that is operated at varying speeds and directions.

Control management of the power inverter 216 is provided by a vehicle control module (VCM) 220 that is operably connected to the power inverter 216 via signal line 222. The VCM 220 is configured to adjust at least one of the output voltage and the output frequency of the AC power from the power inverter 216. In an embodiment, the VCM 220 is operable according to a controller area network (CAN) bus standard 224.

A throttle pedal 226 operably connected to the VCM 220 receives throttle input from a user and facilitates via the VCM 220 delivery of a control command to the electric motor 204 to adjust a rotational speed of the compressor 202, which may be adjusted in a first direction to increase the throttle and speed of the OCCE 102, or in a second reverse direction to decrease the throttle and speed of the OCCE 102. The rotational speed of the compressor 202 is adjusted via the VCM 220 to increase the air pressure at the air intake system 104 of the OCCE 102 when the throttle pedal 226 is positioned for an increase in speed of the OCCE 102.

In an embodiment, a brake pedal 228 is also operably connected to the VCM 220, and is configured to receive brake input from the user and to facilitate via the VCM 220 delivery of a control command to the electric motor 204 to adjust a rotational speed and/or direction of the compressor 202 to decrease the throttle and speed of the OCCE 102. In an embodiment, the rotational speed and/or direction of the compressor 202 is adjusted to decrease the air pressure at the air intake system 104 of the OCCE 102 when the brake pedal 228 is positioned for a decrease in speed of the OCCE 102. In an embodiment involving a braking action, the compressor 202 is operated in a reverse direction, or in a slowed speed forward direction, to facilitate generation of a vacuum at the air intake system 104 of the OCCE 102.

Power to the power inverter 216 and VCM 220 is provided by a power source 230, which may be a battery, a generator, an ultracapacitor, or any other source of power employable with a vehicle operated by the OCCE 102.

In an embodiment, the VCM 220 includes an electronic processing circuit 232 operable to execute machine executable instructions which when executed by the processing circuit 232 facilitates production of the control command to the electric motor 204 in response to the throttle input from the user, in accordance with one of a plurality of algorithms, the plurality of algorithms being switchable from one of the plurality of algorithms to another one of the plurality of algorithms. In an embodiment, the plurality of algorithms includes two or more of the following: an algorithm for controlling the throttle to provide sporty driving conditions, an algorithm for controlling the throttle to provide cruising driving conditions, an algorithm for controlling the throttle to provide optimized economy driving conditions, and an algorithm for controlling the throttle to provide optimized emissions driving conditions, for example. While example algorithms are described herein above, it will be appreciated that the scope of the invention is not so limited and encompasses other algorithms suitable for a purpose disclosed herein.

In an embodiment, the electric motor 204 is capable of rotating upwards of 75,000-200,000 rpm while developing an output torque of 1-5 Newton-meters (Nm), and the compressor 202 is capable of producing 0-400 cfm (cubic feet per minute) of air mass flow, which is comparable to the air mass flow of a 1.8 L (Liter), 300 HP (Horse power) Otto cycle combustion engine. While the foregoing example provides detailed specifications for speed, torque, air mass flow, engine displacement, and engine horse power, it will be appreciated that these specifications are exemplary only and are not intended to limit the scope of the invention.

In an embodiment, a mass air flow sensor 234 or optionally a manifold absolute air pressure sensor 236 is employed at the inlet of the intake manifold 106 to sense a change in air flow being delivered to the intake manifold 106 from the compressor 202, which is provided as a feedback signal to the VCM 220 for throttle control purposes.

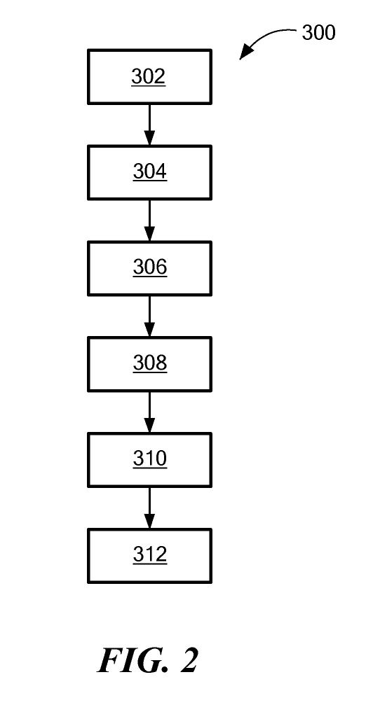

In view of the foregoing, and with reference now to FIG. 2 in combination with FIG. 1, it will be appreciated that TCS 200 is capable of performing a method 300 of controlling a throttle of the OCCE 102 according to the following.

At block 302, a throttle command via the throttle pedal 226 is received at the VCM 220 for adjusting a throttle condition of the OCCE 102.

At block 304, a control signal via the VCM 220 is received at the power inverter 216 for adjusting the output of the power inverter 216.

At block 306, a control voltage via the power inverter 216 is received at the electric motor 204, which is capable of operating in a first direction (forward for example) and a second direction (reverse for example) depending on the polarity of the control voltage, for controlling the speed and/or direction of the electric motor 204.

At block 308, the electric motor 204 is operated in one of the first direction and the second direction, the second direction being reverse of the first direction, and at a controlled speed.

At block 310, and via the electric motor 204, the compressor 202 is rotated in one of a clockwise direction and a counterclockwise direction, and at a controlled speed.

At block 312, and via the compressor 202, the air pressure at the air intake system 104 of the OCCE 102 is adjusted by either increasing the air pressure or decreasing the air pressure, which effectively controls the throttle of the OCCE 102 absent the need for a throttle valve.

In an embodiment, the method 300 at block 308 for operating the electric motor 204 includes operating a permanent magnet electric motor 204.

In an embodiment, the method 300 at block 308 for operating the electric motor 204 includes operating the electric motor 204 in the first direction to cause the compressor 202 to increase the air pressure at the air intake system 104 of the OCCE 102, and includes operating the electric motor 204 in the second direction, reverse to the first direction, to cause the compressor 202 to decrease the air pressure at the air intake system 104 of the OCCE 102.

In an embodiment, the method 300 at block 312 for adjusting the air pressure at the air intake system 104 includes causing air to flow through an unobstructed air flow passage 206 between the compressor 202 and the air intake system 104 of the OCCE 102.

In an embodiment, the method 300 at block 312 for adjusting the air pressure at the air intake system 104 includes creating a vacuum at the air intake system 104.

Some benefits of using the TCS 200 as herein described may include one or more of the following: the ability to package a compressor more closely to the air intake system for improved performance and/or emissions; the ability to reduce air flow disturbances by eliminating a throttle valve in the engine intake air stream; and, the elimination of complex and redundant components in the engine air intake system.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), erasable programmable read only memory (EPROM), electrically erasable programmable read only memory (EEPROM), or flash memory, for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to control the throttle of an Otto cycle combustion engine absent a throttle valve.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A throttle control system for an Otto cycle combustion engine, the system comprising:
a compressor rotatable in both clockwise and counterclockwise directions, the compressor having an air inlet port and an air outlet port, the air outlet port being configured to provide intake air to an air intake system of the Otto cycle combustion engine;
an electric motor operably connected to the compressor, the motor being configured to operate in a first direction to rotate the compressor in one of the clockwise direction and the counterclockwise direction, and in a second direction to rotate the compressor in the other of the clockwise direction and the counterclockwise direction, the second direction being reverse of the first direction; and
an unobstructed air flow passage between the compressor and the air intake system of the engine;
wherein operation of the electric motor in the first direction facilitates an increase in air pressure at the air intake system, and operation of the electric motor in the second direction facilitates a decrease in air pressure at the air intake system.

2. The system of claim 1, wherein the electric motor comprises a permanent magnet rotor.

3. The system of claim 1, wherein the electric motor is directly connected to the compressor via a rotatable shaft.

4. The system of claim 1, further comprising:
a power inverter operably connected to the electric motor, the power inverter configured to transform input DC power to output AC power, at least one of an output voltage and an output frequency of the AC power being adjustable.

5. The system of claim 4, further comprising:
a vehicle control module operably connected to the power inverter, the vehicle control module configured to adjust at least one of the output voltage and the output frequency of the AC power from the power inverter.

6. The system of claim 5, wherein:
the vehicle control module is operable according to a controller area network (CAN) bus standard.

7. The system of claim 6, further comprising:
a throttle pedal operably connected to the vehicle control module, the throttle pedal configured to receive throttle input from a user and to facilitate delivery of a control command to the electric motor to adjust a rotational speed of the compressor.

8. The system of claim 7, wherein:
the rotational speed of the compressor is adjusted to increase the air pressure at the air intake system of the engine when the throttle pedal is positioned for an increase in speed of the Otto cycle combustion engine.

9. The system of claim 6, further comprising:
a brake pedal operably connected to the vehicle control module, the brake pedal configured to receive brake input from a user and to facilitate delivery of a control command to the electric motor to adjust a rotational speed and/or direction of the compressor.

10. The system of claim 9, wherein:
the rotational speed and/or direction of the compressor is adjusted to decrease the air pressure at the air intake system of the engine when the brake pedal is positioned for a decrease in speed of the Otto cycle combustion engine.

11. The system of claim 10, wherein:
the compressor is operated in a reverse direction to facilitate generation of a vacuum at the air intake system of the Otto cycle combustion engine.

12. The system of claim 5, further comprising:
a power source operably connected to the power inverter and the vehicle control module.

13. The system of claim 12, wherein:
the power source comprises a battery.

14. The system of claim 5, wherein:
the vehicle control module comprises an electronic processing circuit operable to execute machine executable instructions which when executed by the processing circuit facilitates production of the control command to the electric motor in response to the throttle input from the user, in accordance with one of a plurality of algorithms, the plurality of algorithms being switchable from one of the plurality of algorithms to another one of the plurality of algorithms.

15. A method of controlling a throttle of an Otto cycle combustion engine, the method comprising:
operating an electric motor in one of a first direction and a second direction, the second direction being reverse of the first direction;
via the electric motor, rotating a compressor in one of a clockwise direction and a counterclockwise direction;
via the compressor, adjusting an air pressure at an air intake system of the Otto cycle combustion engine, wherein the adjusting an air pressure comprises one of increasing the air pressure and decreasing the air pressure.

16. The method of claim 15, wherein the decreasing the air pressure comprises creating a vacuum.

17. The method of claim 15, wherein the operating an electric motor comprising operating a permanent magnet electric motor.

18. The method of claim 15, wherein:
when the electric motor is operating in the first direction, the compressor is increasing the air pressure at the air intake system of the Otto cycle combustion engine; and
when the electric motor is operating in the second direction, the compressor is decreasing the air pressure at the air intake system of the Otto cycle combustion engine.

19. The method of claim 15, wherein the adjusting an air pressure at an air intake system of the Otto cycle combustion engine comprises:
causing air to flow through an unobstructed air flow passage between the compressor and the air intake system of the engine.
